(19) United States
(12) Patent Application Publication
(10) Pub. No.: US 2004/0075391 A1
(43) Pub. Date: Apr. 22, 2004

(54) Flat Light

(76) Inventor: Donald J. E. Miller JR., Tampa, FL (US)

Correspondence Address: Donald J. E. Miller, Jr., 6509 Secrest Ct, Tampa, FL, 33625, US

(21) Appl. No.: 10/358,433

(22) Filed: Feb. 4, 2003

Related U.S. Application Data
(63) Continuation-in-part of application No. 09/973,543, filed on Oct. 9, 2001, now abandoned.

(51) Int. Cl. H01J 17/04; H01J 61/04; H01J 17/16; H01J 61/30

(52) U.S. Cl. 313/634; 313/631

(57) ABSTRACT

Flat Light is a light bulb diamond in shape with a flat top and a spiraling coil for maximum light emissions.

Continuation in Part to application Ser. No. 09/973,543

The flat light is a light bulb that will not have a long neck, and is diamond shaped in form. The light coil inside the bulb sets on four rods in a coil typed circle.

### FIELD OF THE INVENTION

This invention relates to light bulbs, the diamond shape of the bulb and its spiral coil for maximum light. Like other light bulbs the flat light comes in different sizes and wattage.

### BACKGROUND

The Flat Light has a diamond shaped body to give efficient lighting, and its spiraling light coil is exhalent for the task. Four rods being different lengths supports the coils upward spiral.

### SUMMARY

The flat light is like any standard light bulb in use. It comes in various sizes and in wattage such as 60, 75 or 100 ect, except for the shape of the bulb. The flat light has a diamond shaped body with a standard light bulb base for the bottom and the standard glass mount for the center bolder. It has four electrical rods one longer than the other, and these hold the bulbs lighting coil in a spiraling design.

### DESCRIPTION OF DRAWINGS

Page 1. Shows the Flat Light in its finished state.

Page 2. Shows the light coil, the positive, negative and support rods, plus the light bulb base, the glass dome, the glass mount and the flat light cut in half.

Page 3. Shows a perspective of the flat light.

It is to be understood that the present invention is not limited to the details of construction and arrangement of parts illustrated in the accompanying drawings, since the invention is capable of other embodiments, and is capable of being practiced or carried out in various ways within the scope of the claims. Also, it is to be understood, that the phraseology and terminology employed herein is for tie purpose of description, and not of limitation.

### DESCRIPTION OF INVENTION

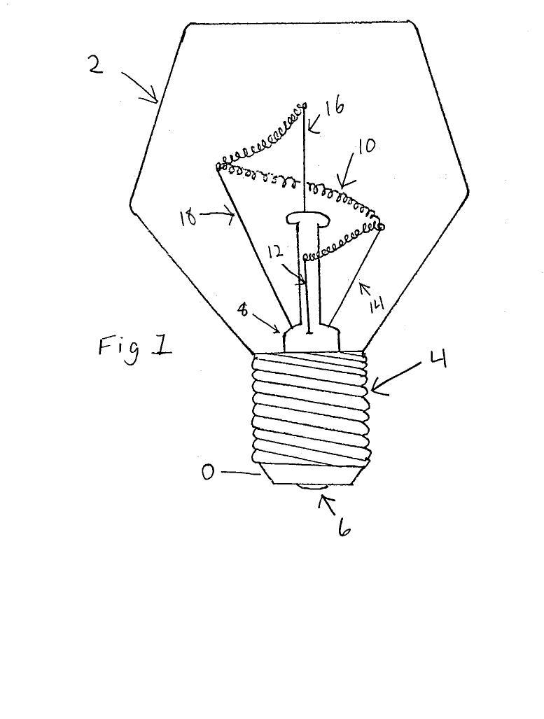

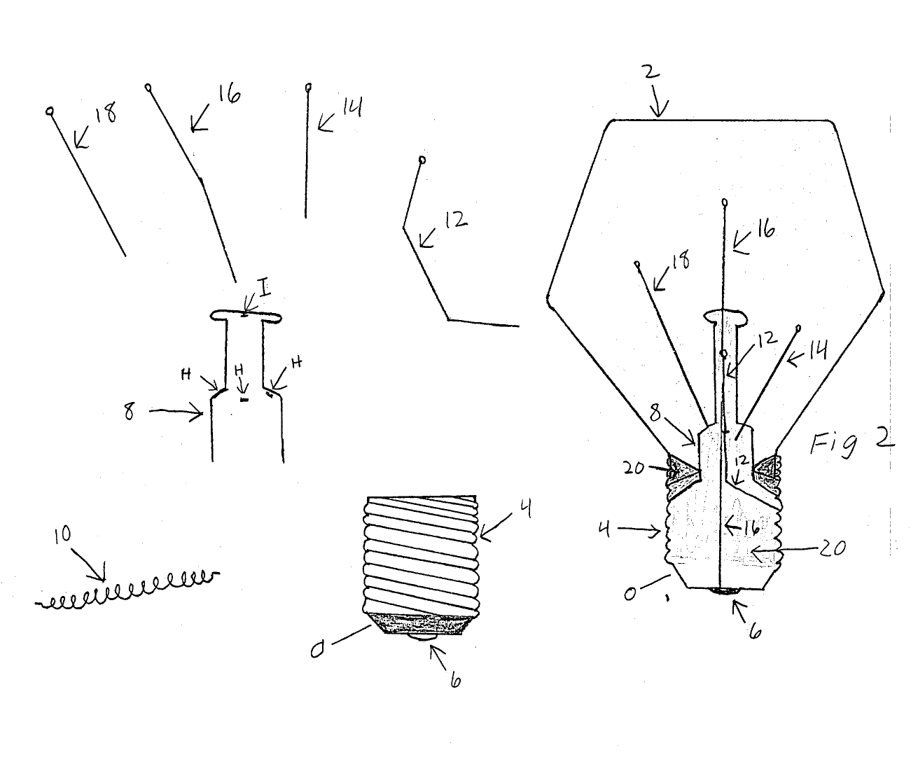

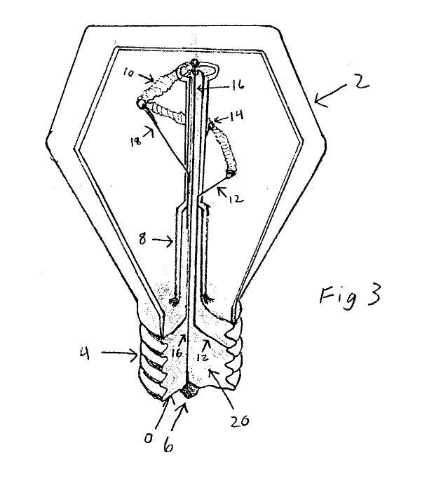

FIG. 3 shows a perspective of the Flat Light. The making of the bulb begins with shaping a glass dome into diamond form 2, and then taking scrap metal and shaping it into a cup with screw threads running around the cup from the top to the bottom 4, these threads are also current collectors. At the bottom center of the base cup is the other current collector 6 and in between the positive and negative collectors is the separator 0. The mount being made from glass has a wide bottom that goes up into a long thin neck 8, and has three holes around the top of the bottom area H and one hole in the top center of the mount I. All rods for the bulb are made of metal, consisting of two contact wires 16, 12 and two support wires 18, 14. These wires are placed in the holes located on the mount, wire 12 being the shortest wire sticking out of the mount is placed first and then 14 being the next longest then 18 and finally 16 being placed in the center hole at the top of the mount.

The glass mount is placed in the bulb base 4 and the contact wires 12 and 16 are secured to the current collectors 4 and 6, the base and mount are filled with insulation 20. And then the lighting coil 10 is connected to each of the rods on the bulb starting with the shortest wire 12 and ending with the top wire 16. The glass diamond shaped dome is then placed over the top and the bottom of the dome is slid into the top of the base and secured with a sealant making the bulb airtight.

01. A light bulb, diamond shaped with spiraling light coil.

02. A light bulb according to claim 01, wherein said bulb has a coil spiraling upwards.
